(19) United States
(12) Patent Application Publication
(10) Pub. No.: US 2005/0130842 A1
(43) Pub. Date: Jun. 16, 2005

(54) Biocidally active combination for agricultural applications

(76) Inventors: Ingo Fleute-Schlachter, Essen (DE); Ewald Sieverding, Johann (DE); Gerd Windbiel, Essen (DE)

Correspondence Address: FROMMER LAWRENCE & HAUG LLP, 745 Fifth Avenue, New York, NY, 10151, US

(21) Appl. No.: 11/006,949

(22) Filed: Dec. 8, 2004

(30) Foreign Application Priority Data
Dec. 10, 2003 (DE) 103 57 682.7

(51) Int. Cl. A01N 57/18; A01N 43/40; A01N 25/04; A01N 25/16

(52) U.S. Cl. 504/206; 504/365

(57) ABSTRACT

The present invention provides a biologically active combination for agricultural applications, comprising A) at least one biocidal, agriculturally acceptable active compound and B) a bioactivator for the active substance according to A) and C) if appropriate, customary auxiliaries and additives, which comprises the use, as bioactivator B), at least one compound of the formula (I)
R—C(O)NH—(CH₂)ₐ—N⁺(R¹,R²)—(CH₂)_{b}—COO— (I) in which R is a hydrocarbon radical having 6 to 22 carbon atoms, preferably 8 to 18 and in particular 10 to 14 carbon atoms, which is optionally branched and/or contains multiple bonds and/or functional groups,
R¹, R² independently of one another are C₁₋₄-alkyl radicals, in particular —CH₃, a is 1 to 5, preferably 2 or 3, b is 1 or 2, in an effective concentration.

### RELATED APPLICATIONS

This application claim priority to German Application Serial No. 103 57 682.7, filed Dec. 10, 2003, herein incorporated by reference.

### BACKGROUND OF THE INVENTION

1. Field of the Invention

The invention relates to a biologically active combination for agricultural applications, comprising at least one biocidal, agriculturally acceptable active compound and a betaine as bioactivator for the active substance.

2. Background of the Invention

In agricultural, horticultural and forestry crops, microorganisms, insects and uncontrolled growth of unwanted plants cause damage which is in some cases immense, for example by adversely affecting the growth of the crops, by damaging the harvested material or by causing yield losses, by reducing the quality owing to feeding damage, by rotting of stored fruits and by contaminating farm equipment.

Such damage can be prevented and/or reduced or limited by targeted application of specific biologically active compounds, such as, for example, pesticides, herbicides, fungicides, insecticides, acaricides, molluscicides, viricides and the like.

A large number of diseases in crop plants are caused by fungal attack. However, diseases in crop plants can also be caused by bacteria.

All parts of crop plants including harvested components are damaged by feeding insects.

Herbicides are used to control the growth of so-called broad-leaved weeds or weed grasses, i.e. of unwanted plants associated with crops, in agriculturally cultivated crops, in horticulture and in the cultivation of ornamental plants and in forestry.

In particular, glyphosate (N-(phosphonomethyl)glycine) and glufosinate and their derivatives are widely used as non-selective herbicides and as regulators of associated growth or as plant growth regulators.

In the prior art, there are a number of publications whose subjects are glyphosate and its various salts and its use as herbicide and plant growth regulator: U.S. Pat. No. 3,799,758; U.S. Pat. No. 4,315,765; U.S. Pat. No. 4,481,026 and U.S. Pat. No. 4,405,531.

A herbicidal action improved by concomitant use of surfactants had been observed and was investigated earlier. In “Glyphosate toxicity to common milkweed and hemp dogbane as influenced by surfactants” in Weed Science, Vol. 25, 1977, pages 275-287, J. B. Wyrill and O. C. Burnside discuss a number of nonionic and cationic surfactants.

They conclude that surfactants which contain amine groups are most effective, and that the effectiveness can be improved even further at increasing HLB values and increasing degrees of ethoxylation. It is stated that in spite of this the chemical structure of a compound is as important or even more important, and that the relation of structure and activity is by no means predictable.

A number of proposals concerning the combination of glyphosates and surfactants are known: U.S. Pat. No. 5,710,104 describes the combination of glyphosate and polyethoxylated primary monoalcohols. U.S. Pat. No. 5,668,085 teaches the combination of glyphosate and alkoxylated amines. U.S. Pat. No. 5,464,807 discloses the combination of glyphosate and alkoxylated quaternary ammonium compounds. EP-A-0 483 095 describes the combination of glyphosate, a silicone copolymer as wetting agent and a cationic or amphoteric surfactant (trialkylbetaine) which is said to give a storage-stable mixture.

WO-A-99/45780 describes a mixture of three herbicides in a suspoemulsion comprising an emulsifier and an aqueous and an oil phase. The emulsifier used can be an amphoteric surfactant.

U.S. Pat. No. 5,912,209 describes a formulation of glyphosate with a secondary alcohol and another surfactant, which may be a betaine (trialkylbetaine).

In WO-A-97/47196, the selection of betaines is likewise limited to trialkyl derivatives, which can be used for improving the action of herbicides. Only derivatives of short-chain amino acids are suitable to ensure a satisfactory solubility in water.

EP-B-0 597 488 teaches a method for enhancing the activity of agrochemicals (=biocidal active substances) using specific quaternary ammonium compounds formula (I)=quaternary diamideammonium compounds (page 7, lines 29-36); formula (II)=H/alkyl(diamide, ester/amide, diester)ammonium compounds (page 7, para. 0022);

formula (III)=quaternary dialkyl(ester/amide)ammonium compounds (page 7, para. 0024) and optionally additional surfactants, such as ionic, nonionic or amphoteric surfactants, reference being made to the lauryldimethylamine oxide Armox C/12, the amine oxides Monaterics and Miranols, and also Betaine and Lonzaine® (functionalized betaines from Lonza e.g. cocoamidopropyl betaine) (page 8, para. 0028).

In practice, the known compositions or formulations of agriculturally acceptable active compounds are frequently unsatisfactory with respect to their usage properties e.g. they have a complex composition, insufficient storage stability, an unsatisfactory activity spectrum and/or insufficient activity.

The viscosity of liquid formulations is often so low that their handling is difficult. When the formulations are filled into spraying apparatus, dangerous situations owing to drift may easily occur, where droplets inadvertently settle on parts of the body of the user and cause damage. To avoid this, thickeners are used for some applications.

### OBJECTS OF THE INVENTION

In general, it is an object of the present invention to overcome the disadvantages of the prior art.

It is another object of the invention to provide a composition which allows the activity of active compounds to be increased and as a consequence, the use concentration of these active compounds to be reduced.

It is a further object of the invention to improve the availability of active compounds in/on plants by using additives as bioactivators.

In summary, it is an object of the present invention to provide an additive which increases the biological activity of biocidal active compounds in a simple mixture, which is well tolerated, which has no irritant effect on the human body and which, in addition to having a broad activity spectrum, has excellent activity at reduced application concentrations.

These and other object, which are apparent from the following description of the invention, are achieved by the combination of a biocidal active compound and an effective amount of at least one betaine of the formula (I).

### DESCRIPTION OF THE INVENTION

Accordingly, the invention provides biologically active combinations for agricultural applications, comprising
A) at least one biocidal, agriculturally acceptable active compound and
B) a bioactivator for the active substance according to A) and
C) if appropriate, customary auxiliaries and additives,
   which comprises, that as bioactivator B), at least one compound of the formula (I)
   R—C(O)NH—(CH₂)ₐ—N⁺(R¹,R²)—(CH₂)_{b}—COO— (I)
   in which
R is a hydrocarbon radical, preferably having 6 to 22 carbon atoms,more preferably 8 to 18 and in particular 10 to 14 carbon atoms, which is optionally branched and/or contains multiple bonds and/or functional groups,
R¹,R² independently of one another are preferably C₁₋₄-alkyl radicals, most preferably particular —CH₃,
a is 1 to 5, preferably 2 or 3,
b is 1 or 2
is used in an effective concentration.

The invention also provides a process for enhancing the activity of aqueous biocidal compositions for agricultural applications containing a biocidal, agriculturally acceptable active compound, if appropriate customary auxiliaries and additives and a bioactivator which comprises an effective amount of at least one compound of the formula (I)
R—C(O)NH—(CH₂)ₐ—N⁺(R¹,R²)—(CH₂)_{b}—COO⁻ (I)
where the individual indices are as defined above.

The invention furthermore provides aqueous storage-stable biocide compositions having improved biocidal activity and comprising about 0.05 to about 50% by weight of an agriculturally acceptable biocide selected from the group of the herbicides or plant growth regulators and about 0.5 to about 50% by weight of a bioactivator of the formula (I)
R—C(O)NH—(CH₂)ₐ—N⁺(R¹,R²)—(CH₂)_{b}—COO— (I)
where the individual indices are as defined above.

The invention furthermore provides a method for regulating the growth of plants, which comprises bringing the plants into contact with an aqueous biocide composition comprising the biologically active combination according to the present invention.

The invention furthermore provides a method for increasing the viscosity of aqueous biocide compositions using substances according to the invention. Such compositions no longer require a thickener to be added.

The bioactivators in the sense of the present invention can also generally be formulated as concentrates with all active compounds in the commercial sector and, in areas which are not agriculturally utilized, prior to dilution to a concentration customary used for application.

The formulation can also preferably be prepared in the tank by separately adding and mixing, in a water tank, bioactivator and active compounds and, if appropriate, also other auxiliaries, prior to application preferably by spraying. The order in which the components are added is not important. The concentration of the active compound is the concentration that is usually employed to obtain the desired effect of the active compound, usually in a concentration from about 0.0001 to at most about 50% by weight, preferably in a concentration from about 0.01 to about 10% by weight.

The preparation of the bioactivators according to the invention is described in EP-B-0 560 114 which, by reference, is part of the present disclosure.

For the purposes of the patent, bioactivators are compounds which increase the biological activity of active compounds by improving the absorbability into the plant tissue or into the target surface. Bioactivation may also be achieved by an improved biological availability of the active compound or active compounds for organisms on the target surface. This improves the biological activity of the active compound(s) in and/or on the treated targets. The biocides whose activity is enhanced by bioactivators are preferably agriculturally acceptable active compounds. However, active compounds used in the non-agricultural sector for protection against insects, diseases, unwanted plants and the like, and for protection against bacteria, viruses, slugs and snails, shells, animals and the like, are not excluded.

Agriculturally acceptable active compounds are active compounds which are approved in the individual countries of the world as such, for application in crop protection or in the prevention of damage to crop plants or materials. They can be either synthetic active compounds or else active compounds on a biological basis, which may include both extracts and live organisms having antagonistic action.

Suitable agriculturally acceptable active compounds are acaricides (AC), algicides (AL), attractants (AT), repellants (RE), bactericides (BA), fungicides (FU), herbicides (HB), insecticides (IN), molluscicides (MO), nematicides (NE), rodenticides (RO), safeners (SA), sterilants (ST), synergists (SY), viricides (VI), growth regulators (PG), alone or in combination. Among these, preference is given to HB, FU, IN, NE, AC or PG, and particular preference is given to HB, FU, IN.

In a preferred embodiment, the term “active compounds” is to be understood as meaning all suitable active compounds known to the person skilled in the art.

Classes of active compounds, active compound substances or organisms as biocidal, agriculturally acceptable active compounds together with their use or their uses are listed, for example, in the handbook “The Pesticide Manual”, 12th edition 2002, The British Crop Protection Council, and in the literature cited therein.

A selection of but not limited to are: AC for example: abamectin, bromocyclen, clofentezin, diazinon, tebufenpyrad; AL for example: dichlorophen; AT for example: 3,7-dimethyl-2,6-octadien-1-ol; RE for example: anthraquinone, citronellol, Daphne oil, guazatine, sebacic acid; BA for example: streptomycin, propionic acid, pentylphenol, dichlorophen; FU for example: epoxiconazole, fenpropidine, azoxystrobin, mancozeb, carbendazim, fenhexamid, sulfur, carpropamid; HB for example: atrazine, bentazone, dicamba, glufosinate including its salts, glyphosate including its salts and derivatives, glufosinate including its salts and derivatives, metamitron, metalachlor, nicosulfuron, paraquat, picolinafen, pendimethalin, rimsulfuron, quinclorac; IN for example: acetamiprid, cypermethrin,.imidacloprid, pirimicarb, spinosad; MO for example: ethanol, thiodicarb, metaldehyde, MCPA-thiethyl, aluminum sulfate; NE for example: benfuiracarb, carbosulfan, fenamiphos, oxamyl, thionazin; RO for example: papain, bromethalin, calciferol, coumafuryl, fluoroacetamide; SA for example: benoxacor safener, cloquintocet-mexyl safener, fenchlorim safener, mefenpyr-diethyl safener; ST for example: dazomet, 1,2-dichloropropane; SY for example: piperonyl butoxide, sulfaquinoxalin; PG for example: sea algae extract, gibberellic acid, indolylbutyric acid and cyanamide, these examples are not to be construed as limitations.

In a further embodiment, suitable biocidal active compounds are biological crop protection agents and pesticides. These preferably include bacteria, slime fungi and other fungi, nematodes, viruses or substances or other components therefrom. Suitable are, preferably, Bacillus spp. (for example B. sphaericus IN, B. subtilis FU, B. thuringiensis IN with B. thuringiensis aizawai, B. thuringiensis israelensis, B. thuringiensis kurstaki, B. thuringiensis tenebrionis), Pseudomonas spp., Streptomyces griseoviridis FU, Ampelomyces quisqualis FU, granulosis viruses IN or, for example, nuclear polyhedrosis viruses IN.

The composition according to the invention comprises the biocidal active compound (a) preferably in an amount in a range from about 0.0005 to about 80% by weight, in particular in an amount of about 0.05 to about 50% by weight, in each case based on the total weight of the composition.

For application to the target organisms or target locations or target plants, these are diluted with water, or else with aqueous solutions which may contain other active compounds or nutrient solutions, or they are, prior to application, diluted with organic solvents, such as oils. The incorporation of active compounds together with the bioactivators according to the invention and other components into solid preparations or formulations such as powders, dusts, granules or tablets is also possible. How to prepare concentrated preparations such as EC (emulsion concentrates U.S. Pat. No. 6,566,308 or US-A-2003-0083201), SC (suspension concentrates WO-A-01/30156), WG (water-dispersible granules EP-B-0 252 897 or EP-B-0 224 845), WIP (wettable powders WO-A-03/055306) and the like is known to the person skilled in the art. These publications are incorporated into the present invention by way of reference.

In another embodiment, the active compounds, in the form of active compound compositions comprising the active compound and formulating agents, such as, for example, organic solvents, antifoams, inorganic salts, thickeners, chelating agents, surfactants, pH regulators, colorants, can be mixed with the water and the additive.

Suitable antifoams are those based on silicone, mineral or vegetable oils, which can be emulsions or self-emulsifiable concentrates. These may contain silicic acid or other hydrophobic particles. To enhance the activity, it is possible to add organo-modified siloxanes.

In a preferred form of the present invention, the inorganic salt added is ammonium sulfate. This is added, firstly, because it acts as a fertilizer. Secondly, in the case of phosphorus-containing organic acids and derivatives thereof, it has been found to be advantageous for the biocidal action to add ammonium sulfate. It is also possible to add other sulfates.

Chelating agents which can be used are the compounds known in this field, such as, for example, chelating agents of the aminopolycarboxylic acid type, of the type of aromatic or aliphatic carboxylic acids, of the amino acid type, chelating agents of the etherpolycarboxylic acid type, iminodimethylphosphonic acid (IDP), dimethylglyoxime (DG) and alkyldiphosphonic acids (ADPA). These chelating agents are used in pure form or in the form of their sodium, potassium or ammonium salts.

Suitable pH regulators are in particular organic and inorganic acids, such as citric acid, gluconic acid, acetic acid, hydrochloric acid, phosphoric acids and salts thereof, furthermore organic and inorganic bases, such as isopropylamine, tallow fatty amines, ammonia and salts thereof.

The thickeners which can be used are the known natural and synthetic water-soluble products, such as, for example, guar gum, xanthan gum, zanflow, pectin, gum arabic, methylated, carboxyalkylated and hydroxyalkylated cellulose products, such as, for example, methylcellulose, carboxymethylcellulose and hydroxymethylcellulose, methylated, carboxyalkylated and hydroxyalkylated starch derivative products, sorbitol, polyacrylates, polymaleates, polyvinylpyrrolidone and pentaerythritol/ethylene oxide adducts.

The invention fulrthermore relates to the use of the activator (B), preferably in the form of a concentrated aqueous formulation, to increase the activity of the active compound compared to the same amount of active compound being applied without activator (B), under otherwise identical conditions, for controlling an organism. An activity increase in the control of an organism is present if, in the control of an organism, the activity in the presence of the bioactivator is greater than the control of an organism in the absence of the bioactivator.

The invention furthermore relates to the use of the bioactivator according to the invention in a composition comprising a combination of active compounds of at least one active compound (A) and, to improve its activity, at least one activator (B) in the sense of the general formula (I), where the combination of agriculturally acceptable active compound or active compounds with the activator acts synergistically. Synergism is present when the observed activity of the combination is greater than the expected activity of the combination. The determination of synergistic effects is described in: Colby, S. R. (1967): “Calculating Synergistic and Antagonistic Responses of Herbicide Combinations”, Weeds, 15: pp. 20-22. Surprisingly, it has been found that the additives in the sense of formula (1) are bioactivating, where bioactivation has to be assumed if the activator, as only product without the active compound, has no activity whatsoever, but the active compound in combination with the activator shows increased activity.

Preferred active compounds for the applications or as active compounds in the combination of active compounds for controlling an organism are those active compounds mentioned in connection with the composition according to the invention which are capable of controlling organisms.

Organisms are preferably harmful plants, in particular harmful broad-leaved weeds and weed grasses, harmful fungi, harmful animals, such as, for example, harmful insects, harmful bacteria, harmful nematodes and harmful viruses.

Organisms which are controlled by the composition according to the invention are located on or in a substrate. Preferred substrates are entire plants or parts of plants, such as stems, branches, blossoms, leaves, whole or divided roots or tubers, seed grains, seeds, produce or fruit.

The invention furthermore relates to the use of the activator (B), preferably in the form of an aqueous solution, for increasing the activity of the active compound (A) compared to the same amount of active compound applied without the activator (B), under otherwise identical conditions, for regulating the growth of a plant.

Preferred active compounds for the applications or the application in a combination of active compound for controlling weeds and/or for regulating the growth of a plant are those active compounds mentioned in connection with the composition according to the invention which are capable of regulating and/or controlling the growth of plants, such as, by way of example and preferred according to the invention, organophosphorus compounds, preferably organic acids, such as, in particular, glyphosate and glufosinate and derivatives thereof, particularly preferably those having ammonium, isopropylammonium, sodium, potassium or trimesium cations.

The invention furthermore relates to a method for regulating the growth of a plant, by bringing the plant into contact with the compositions according to the invention.

The bringing into contact with the compositions according to the invention is preferably carried out by brushing-on, dipping or spraying, spraying being particularly preferred.

The compositions according to the invention are preferably sprayed on from a spray tank via known devices, such as, for example, spray nozzles.

The invention furthermore relates to the use of the compositions according to the invention in agriculture, in forestry, in horticulture, in the cultivation of fruit, in vector control, in the propagation of plants, in plant breeding, in seed, in planting materials, in nonagricultural applications, for the control or for combating organisms, in storage or processing of fruits and harvested crops or plant materials.

Preference is given to using the compositions according to the invention as sprays on plant materials, preferably leaves and stems, as a fungicide, as an insecticide and, in particular, as a herbicide or as a plant growth regulator.

Below, the invention is illustrated in more detail by test methods and non-limiting examples.

Examples of formulations comprising the compounds of the formula I according to the invention:

Betaines having various alkyl chain lengths of the radical R were prepared (table 1) before being converted into a composition with glyphosate.

TABLE 1
Betaines synthesized having various alkyl chain lengths:

| | Chain length of the | | |
|---|---|---|---|
| Example No. | betaine | Solids (%) | Water (%) |
| A1 | C₆ | 60 | 40 |
| B1 | C₈ | 45 | 55 |
| C1 | C₁₀ | 40 | 60 |
| D1 | C₁₂ | 35 | 65 |
| E1 | C₁₄ | 29.9 | 70.1 |
| F1 | C₈-C₁₈ (coconut fatty | >98 | <2 |
| | acid) | | |
| G1 | C₈-C₁₈ (coconut fatty | ˜47 | ˜53 |
| | acid) | | |
| H1 | C₈-C₁₀ | ˜43 | ˜57 |

Solids are to be understood as meaning the content which remains after evaporation of water. The examples of table 1 are the technical-grade mixture of the betaines prepared according to EP-B-0 560 114. F 1 is a spray-dried betaine. H 1 is based on relatively short alkyl chains and is thus low-foam. The substances A 1 to H 1 were then used in a formulation with glyphosate (table 2). Here, the content of the isopropylamine salt (IPA) of glyphosate was adjusted to a certain content of acid equivalents (a.e.).

TABLE 2
Glyphosate formulations prepared (water added ad 1 liter):

| | | Glyphosate | Betaine solids |
|---|---|---|---|
| Example | | content | content |
| No. | Betaine used | (g of a.e./l) | (g/l) |
| A2 | A1 | 288 | 60 |
| B2 | B1 | 288 | 60 |
| C2 | C1 | 288 | 60 |
| D2 | D1 | 288 | 60 |
| E2 | E1 | 288 | 54 |
| F2 | F1 | 288 | 60 |
| G2 | G1 | 288 | 60 |
| H2 | H1 | 288 | 60 |

Compositions comprising either an active compound (I to M and S to W) or no active compound (N to R) are compiled in the examples below. The compositions may also comprise additives such as ammonium sulfate and/or agents to prevent the formation of foam. The antifoams BREAK-THRU® AF 9904 and TEGO® Antifoam MR 2222 are commercial products from Goldschmidt AG.

TABLE 3
Formulation examples of glyphosate-IPA with betaines
and antifoams (water added ad 1 liter):

| | Glyphosate | | | | AF | |
|---|---|---|---|---|---|---|
| Example | content | G1 | H1 | (NH₄)₂SO₄ | 9904 | MR 2222 |
| No. | (g of a.e./l) | (ml) | (ml) | (g) | (ml) | (ml) |
| I | 480 | 130 | | | | |
| J | 480 | 130 | | | 1 | |
| K | 480 | 130 | | | 2.5 | |
| L | 480 | 130 | | | 5 | |
| M | 480 | 130 | | | | 2.5 |
| N | | 652 | | 190 | 5 | |
| O | | | 714 | 280 | | |
| P | | 652 | | | | |
| Q | | 652 | | | 3 | |
| R | | 652 | | 190 | 3 | |
| S | 360 | 130 | | 90 | 1 | |
| T | 288 | 130 | | 160 | | |
| U | 480 | | | | | |
| V | 360 | | | | | |
| W | 360 | 130 | | | | |

Table 4 shows the measured amounts of foam above the water/air interface of formulations of 2% strength solutions. This corresponds to the concentration of the spray liquid applied to plants. The foam formation was determined in a measuring cylinder having a volume of 100 ml and an internal diameter of 30 mm after addition of 50 ml of the aqueous solution and shaking by hand (30 strokes), after 10 seconds.

TABLE 4
Foam formation and appearance of formulations after addition of water
(2% strength aqueous solution)

| | Appearance of | |
|---|---|---|
| Formulation | the undiluted | Amount of foam in a 2% |
| No. | formulation (tab. 3) | strength aq. Solution [ml] |
| I | transparent | 70 |
| J | transparent | 30 |
| K | transparent | 15 |
| L | turbid | 10 |
| M | very turbid | 30 |
| O | transparent | — |
| P | transparent | 80 |
| Q | turbid | 30 |
| S | turbid | — |
| T | transparent | — |

The results show that BREAK-THRU® AF 9903 is a highly effective antifoam (examples J to L) which, however, causes the formulation to become turbid at higher concentrations (example L). In the formulation M, even small amounts of the alternative antifoan MR 2222 are, on the one hand, effective, but, on the other hand, not compatible. Example O shows that ammonium sulfate can be added to an example from the bioactivators according to the invention, giving a transparent composition suitable for use as a separate additive to the spray liquid.

Ammonium sulfate may be a component of an active-compound-containing transparent formulation with betaine (example T); however, a further addition of antifoam AF 9904 causes incompatibility even if the amount of ammonium sulfate is halved compared to example T (example S).

When comparing examples K and Q, it can be observed that the presence of active compound in example K gives a transparent composition, in contrast to example Q. Glyphosate obviously acts as a solubilizer for the antifoam AF 9904.

Test of the increase in the viscosity of the formulation:

The formulation examples I and U differ only in that U does not contain a bioactivator. The viscosities of the formulations were determined in a laboratory at 20° C. according to the method known to the person skilled in the art using the Brookfield viscometer, Model LV, spindle No. 2, at 30 rotations per minute. As a result, it was found that formulations I and U have viscosities of 74 mPas and 120 mPas, respectively. Formulation examples V and W likewise only differ in that V does not contain a bioactivator. For formulations V and W, the viscosities were determined as being 15 mPas and 25 mPas, respectively. Thus, surprisingly, the added bioactivator gives a formulation which, from a technical point of view, is easier to handle and can be introduced into the spray tank more safely since the higher viscosity of the formulation does not reduce its pourability but does reduce the risk of drift caused by strong wind during filling into the spray tank. By virtue of the higher viscosity, there is thus a lower risk of contamination of the user of the formulation, with the solution of active compound, and thus a reduced risk of a composition in the sense of the patent causing irritation on the human body.

Test of the enhancement of the biological activity by bioactivators in the sense of the patent:

### EXAMPLE 1

The following plant species were sown in a field to investigate the control of plants which are also referred to as broad-leaved weeds or weed grasses:

Three broad-leaved weeds: Ipomea grandifolia (IAQGR), Euphorbia heterophylla (EUPHL), Senna tora (synonymous with Cassia obtusifolia (CASOB)), and three weed grasses: Brachiaria plantaginea (BRAPL), Echinocloa colonum (ECHCO) and Eleusine indica (ELEIN).

The plants were sprayed with the formulations A 2 to E 2 (table 2) in comparison with Roundup®, a commercial glyphosate formulation from Monsanto which comprises 360 g of a.e.l and is known in agricultural practice as a highly effective formulation. 1 1/ha, 1.5 1l/ha and 2 l/ha of the commercial formulation and of formulations A 2-E 2 were, after dilution in 100 l of water, sprayed via nozzles onto the plants when they were flowering or in an active growth stage, i.e. had a height of about 30 to 50 cm. Each treatment was repeated on 4 small plots.

21 days after the treatment of the plants, the dead and necrotized area of the plants was estimated in percent in comparison to untreated plants, a method for scoring the activity of herbicides which is known to the people skilled in the art. The activity results (% of control) are shown in table 5 in an exemplary manner for the broad-leaf weed CASOB and the weed grass ECHCO:

TABLE 5
Activity (% of control)

| | | Control (%) | | |
|---|---|---|---|---|
| Plant | Treatment | 1 l/ha | 1.5 l/ha | 2 l/ha |
| CASOB | Roundup | 76.7 | 86.7 | 96.0 |
| | A2 | 48.3 | 76.7 | 83.3 |
| | B2 | 56.7 | 86.7 | 93.3 |
| | C2 | 89.0 | 88.3 | 96.0 |
| | D2 | 78.3 | 85.0 | 96.0 |
| | E2 | 71.7 | 88.3 | 100 |
| ECHCO | Roundup | 61.7 | 83.3 | 93.3 |
| | A2 | 66.7 | 83.3 | 93.3 |
| | B2 | 63.3 | 88.3 | 93.3 |
| | C2 | 63.3 | 96.7 | 95.0 |
| | D2 | 61.7 | 85.0 | 95.0 |
| | E2 | 63.3 | 86.7 | 93.3 |

The table shows that betaines C 1 to E 1 combined with glyphosate enhance the activity of glyphosate to such an extent that the results for formulations C 2 to E 2 were similar to the commercial standard Roundup or, in some dosages, superior, even though 20% less of herbicidally active compound were applied! Surprisingly, the activity of formulation C 2, which contained betaine C 1, exceeded that of the commercial standard considerably, in particular at the low application rates of 1 l/ha and 1.5 l/ha, although here, too, 20% less herbicide was used.

### EXAMPLE 2

A field trial was initiated in which the herbicidal action of the example formulations F 2 and G 2 was compared to that of the commercial glyphosate formulations Roundup® Ultra (RUU) from Monsanto and Glyfos® from Cheminova (GLY) comprising in each case 360 g of a.e/l of glyphosate. For this purpose, using flat fan spray nozzles, amounts of the formulation corresponding to 2 l/ha and 4 l/ha, dissolved in 200 l/ha of water, were applied onto plots of an area of 18 m². Each treatment was applied to four plots. The entire field had an evenly distributed plant stand of maize (Zea mays, soil coverage 14%), Echinochloa crus-galli (ECHCG), soil coverage 17%, Chenopodium album (CHEAL), soil coverage 24%, Chenopodium polyspermum (CHEPO), soil coverage 6%, Amaranthus retroflexus (AMARE), soil coverage 29% and Solanum nigrum (SOLNI), soil coverage 6%, when the compositions were applied. At the time of spraying, the plants had a height of about 30 to 45cm.

The effectiveness of the treatment (% of control) was scored using the browned and necrotized area of the individual plant species compared to untreated plants 11, 22 and 33 days after the treatment. This method of scoring herbicides is familiar to the person skilled in the art. The activity of the formulations, prepared according to the invention, for the regulation of growth of maize and for the control of ECHCG and also AMARE and SOLNI, by way of example, is shown for 33 days after the treatment (DAT).

TABLE 6
Effectiveness (% of control) 33 days after the treatment (DAT):

| Treatment | Dosage | Maize | ECHCG |
|---|---|---|---|
| formulation | l/ha | 33 DAT | 33 DAT |
| RUU | 2 | 34 | 48 |
| | 4 | 89 | 87 |
| GLY | 2 | 15 | 10 |
| | 4 | 89 | 89 |
| F2 | 2 | 30 | 45 |
| | 4 | 91 | 93 |
| G2 | 2 | 68 | 35 |
| | 4 | 96 | 93 |

The formulations F 2 and G 2 were superior to the GLY formulation, and, in maize, the formulation G 2 was superior to both commercial glyphosate formulations, even at low application rates; in particular at the higher application rate of 4 l/ha, F 2 and G 2 were more effective against ECHCG6). The superior action of F 2 and G 2 is also emphasized by the fact that the concentration of glyphosate in formulations F 2 and G 2 was 20% lower than that in RUU and GLY. Thus, by adding the betaines F1 and G1 to the active compound, it is possible to reduce the active compound applied per hectare compared to commercial compositions, whilst maintaining very good effectiveness against weeds,

TABLE 7
Effectiveness (% of control) 33 days after the treatment (DAT):

| Treatment | Dosage | AMARE | SOLNI |
|---|---|---|---|
| formulation | l/ha | 33 DAT | 33 DAT |
| RUU | 2 | 48 | 28 |
| | 4 | 89 | 46 |
| GLY | 2 | 3 | 0 |
| | 4 | 73 | 83 |
| F2 | 2 | 24 | 41 |
| | 4 | 88 | 93 |
| G2 | 2 | 86 | 33 |
| | 4 | 97 | 95 |

The results in table 7 show that formulations F 2 and G 2 were more effective than GLY, and that both formulations were more effective than RUU against the broad-leaf weed SOLNI, which is difficult to control. Even at a low dosage, the formulation G 2 had excellent activity against AMARE. The superior action of F 2 and G 2 is also underlined by the fact that the concentration of glyphosate in formulations F 2 and G 2 was 20% lower than that in RUU and GLY. Thus, by adding betaines F 1 and G 1 to the active compound, it is possible to reduce the active compound applied per hectare compared to commercial compositions, while maintaining very good effectiveness against broad-leaved weeds.

The results of example 2 show that even commercially available betaines, which are available on the market particularly in solid or liquid form, have a bioactivating action which corresponds to that of C-chain-pure betaines, i.e. betaines based on specific fatty acids, or which exceeds this action. The fatty acid composition in the coconut fat on which F 1 and G 1 are based have a particularly pronounced effect on the bioactivating action. Thus, in a preferred embodiment, a mixture of fatty acids having 10, 12 and 14 carbon atoms is used. Such a mixture may be of a natural type, such as in coconut fat or palm oil, or be produced by selective mixing of the pure fatty acids.

TABLE 8
Composition of the fatty acids in coconut fat (saturated fatty
acids/100 g of fatty acid) according to Ullmanns Encyclopedia
of Industrial Chemistry, VCH Verlag, 5th edition 1987:

| C₁₀ | C₁₂ | C₁₄ | C₁₆ | C₁₈ | C₂₀ |
|---|---|---|---|---|---|
| ˜13 | 41-46 | 18-21 | 9-12 | 2-4 | traces |

These betaines are, based on a solids concentration of 6% in the glyphosate formulation, cheaper than formulation auxiliaries and activity enhancers currently used in the commercial glyphosate formulations. Currently, it is mainly tallow fatty amines and derivatives thereof which are used for enhancing the activity of glyphosate. The test results show that the activity of the novel betaine-containing formulations F 2 and G 2 is highly superior, in particular at low dosages, to Glyfos®, which contains an ethoxylated tallow fatty amine to enhance the activity. Thus, the betaines described in this invention have produced a superior bioactivating action in the sense of the invention.

### EXAMPLE 3

In a further field trial, the bioactivation of the commercial glyphosate formulation Glyfos® from Cheminova (with 360 g of a.e./l of glyphosate) by the bioactivator Q was examined. To this end, 1.5 l/ha or 3 l/ha of Glyfos® were dissolved in 200 l/ha of water, and 0.5 l/ha of bioactivator Q or no bioactivator Q was added to this water. The mixture was stirred and equivalent amounts were applied with flat fan spray nozzles to plots of an area of 18 m². Also applied were 0.5 l/ha of bioactivator Q alone, without Glyfos®. Each treatment was carried out in four plots. The entire field had an evenly distributed plant stand of wheat and 7 broad-leaved weeds, the main weeds being Galinsoga parviflora (GASPA), 24% soil coverage, and Chenopodium album (CHEAL), 26% soil coverage. When the compositions were applied, wheat (TRZAW) had a soil coverage of 5%. At the time of spraying, the plants had a height of about 15 to 30 cm.

The effectiveness of the treatment (% of control) was scored 5, 10 and 20 days after the treatment using the browned and necrotized area of the entire plant stand and the individual plant species compared to untreated plants. This scoring method for the activity of herbicides is familiar to the person skilled in the art. By way of example, the effectiveness of the treatments in the entire stand is shown in table 9.

TABLE 9
Effectiveness of mixtures 20 days after the treatment:

| | | | | Total | Total stand |
|---|---|---|---|---|---|
| Treat- | Dosage | | Dosage | stand % | % of |
| ment | l/ha | Bioactivator | l/ha | of control | control |
| Glyfos | Glyfos | formulation | Bioactivator | found | expected |
| Glyfos | 1.5 | none | | 73 | |
| Glyfos | 3.0 | none | | 83 | |
| Glyfos | 1.5 | Q | 0.5 | 88 | 73 |
| Glyfos | 3.0 | Q | 0.5 | 92 | 83 |
| None | | Q | 0.5 | 0 | |

The results in table 9 show that by adding Q to the tank mix, the activity of Glyfos was increased considerably, even though the additive Q for its part had no activity. For both dosages of active compound, the activity for the combination of active compound in Glyfos with bioactivator Q which had actually been found was considerably higher than the expected activity which would have resulted from the sum of the activities of active 10 compound formulation and bioactivator formulation. Surprisingly, the combination results in synergistic effects (according to Colby, S. R., 1967: “Calculating Synergistic and Antagonistic Responses of Herbicide Combinations”, Weeds, 15: pp. 20-22).

### EXAMPLE 4

The bioactivation of the commercial fungicide formulation Opus-Top® from BASF (which contains 84 g of a.i/l of epoxiconazole +250 g of a.i./l of fenpropimorph) by the bioactivator formulation Q against plant diseases was examined in a field trial in winter wheat of the cultivar “Hattrick”. To this end, 0.75 l/ha of Opus Top were dissolved in 300 l/ha of water, and no bioactivator Q or 0.5 l/ha of bioactivator Q were added separately to this water. The mixture was stirred and equivalent amounts were, using flat fan spray nozzles, applied to plots of an area of 25 m². Each treatment was carried out in four plots. Untreated plots were also established. The first application by spraying the above-ground plant materials was carried out at the growth stage BBCH 32-33 (height of plants about 42-45 cm) and the second at BBCH 51-55 (height of plants about 75-85 cm). The leaves of the wheat crop were naturally infected by Septoria tritici and wheat rust, two feared and highly damaging diseases of wheat. The onset of the diseases on the leaves was scored at various points in time (in % of infected leaf area), as is familiar to the person skilled in the art. The lower the disease level, the more effective the treatment. The effectiveness of the treatment with the fungicide and the bioactivator is shown by way of example by the scoring results for the flag leaf of the wheat. The flag leaf is the uppermost and most important leaf of the plant. Assimilates of the flag leaf are incorporated directly into the cereal grain, and the healthier the flag leaf, the higher the yield. Scoring for Septoria tritici (Septoria leaf blotch) was carried out 24 days after the second application, scoring for wheat rust was carried out 45 days after the second application. The results are shown in table 10. At no point in time during the cultivation was damage caused by the treatments observed. This means that the bioactivator causes no phytotoxicity.

TABLE 10
Effectiveness against plant diseases:

| | | Wheat rust |
|---|---|---|
| | Septoria tritici disease | % of infected leaf |
| Treatment | % of infected leaf area)¹ | area)¹ |
| Untreated | 6.5 a | 17.4 a |
| Opus Top | 5.3 a | 20.3 a |
| Opus Top + bioactivator Q | 0.0 b | 8.9 b |

¹Numbers in the same column with the same letter are, statistically, not significantly different (P = 0.05)

The results in example 4 show that the bioactivator in the sense of the invention causes no damage to the crop plants when it is combined with fungicides. The results in table 10 clearly show that, by adding the bioactivator in the sense of the invention, the commercial fungicide was bioactivated, since it had no activity whatsoever without bioactivator. Taking into account that, as is also shown in example 3, the bioactivator for its part has no biological action, here, with fungicides, there is likewise a synergistic effect in combination with bioactivator.

The examples given here refer to herbicides and fungicides. However, the examples do not preclude a bioactivating activity of the betaines in the sense of the invention and synergistic effects for other active compounds. It is to be expected that the bioactivating action of the betaines in the sense of the invention applies also to other agriculturally acceptable active compounds. Accordingly, the examples shown here have only exemplary character for all pesticides and biocides in the sense of the invention.

The above description is intended to be illustrative and not limiting. Various changes may occur to those skilled in the art. These changes can be made without departing from the scope or spirit of the invention.

1. A biologically active combination for agricultural applications comprising
A) at least one biocidal, agriculturally acceptable active compound;
B) an effective amount of at least one bioactivator which is a compound of the formula
R—C(O)NH—(CH₂)_{a—N}⁺(R²,R²)—(CH₂)_{b}—COO⁻ (I)
in which
R is a hydrocarbon radical which is optionally branched and/or contains multiple bonds and/or functional groups,
R¹, R² independently of one another are alkyl radicals,
a is 1 to 5,
b is 1 or 2;
C) optionally, at least one customary auxiliary or additives.

2. The biologically active combination according to claim 1, wherein the bioactivator is a compound of the formula
R—C(O)NH—(CH₂)ₐ—N+(R¹,R²)—(CH₂)_{b—COO}⁻ (1)
in which
R is a hydrocarbon radical having 6 to 22 carbon atoms, which is optionally branched and/or contains multiple bonds and/or functional groups,
R¹, R² independently of one another are C₁₋₄-alkyl radicals,
a is 1 to 5,
b is 1 or 2.

3. The biological active combination according to claim 2, wherein the customary auxiliary or additive is at least one compound selected from the group consisting of a solvent, biocide-compatible salt, a thickener, antifoam, chelating agent, and sulfactant pH regulator.

4. The biological active combination according to claim 3, wherein
R is a hydrocarbon radical having 8 to 18 carbon atoms.

5. The biological active combination according to claim 3, wherein
R is a hydrocarbon radical having 10 to 14 carbon atoms
R¹, R² are a CH₃ group,
a is 2 to 3,
b is 1 or 2,
and the customary auxiliary or additive is at least one compound selected from the group consisting of a solvent, biocide-compatible salt, a thickener, antifoam, chelating agent, and sulfactant pH regulator.

6. The biologically active combination as claimed in claim 1, the biocidal, agriculturally acceptable active compound is an acaricide, algicide, attractant, repellant, bactericide, fungicide, herbicide, insecticide, molluscicide, nematicide, rodenticide, safener, sterilant, synergist, viricide, growth regulator, alone or in combination.

7. The biologically active combination as claimed in claim 1, wherein the biocidal, agriculturally acceptable active compound is at least one organophosphorus compound or derivatives thereof.

8. The biologically active combination as claimed in claim 1, wherein said biocidal active compound is synergistic.

9. The biologically active combination as claimed in claim 8, wherein the biocidal active compound is a fungicide or a glyphosate or derivative thereof or salt thereof.

10. A method for enhancing the activity of aqueous biologically active compositions for agricultural applications comprising a biocidal, agriculturally acceptable active compound, optionally customary auxiliaries and additives, by adding an effective amount of at least one bioactivator of the formula
R—C(O)NH—(CH₂)ₐ—N⁺(R¹,R²)—(CH₂)_{b}—COO⁻ (I)
in which
R is a hydrocarbon radical which is optionally branched and/or contains multiple bonds and/or functional groups,
R¹, R² independently of one another are alkyl radical
a is 1 to 5,
b is 1 or 2.

11. The method according to claim 10, wherein the biolactivator is a compound of the formula
R—C(O)NH—(CH₂)ₐ—N⁺(R¹,R²)—(CH₂)_{b}—COO⁻ (I)
in which
R is a hydrocarbon radical having 6 to 22 carbon atoms, which is optionally branched and/or contains multiple bonds and/or functional groups,
R¹, R² independently of one another are C₁₋₄-alkyl radicals,
a is 1 to 5,
b is 1 or 2.

12. The method as claimed in claim 10, wherein the agriculturally acceptable active compound is an acaricide, algicide, attractant, repellant, bactericide, fungicide, herbicide, insecticide, molluscicide, nematicide, rodenticide, safener, sterilant, synergist, viricide, growth regulator, alone or in combination of these.

13. The method as claimed in claim 10, wherein the herbicide is selected from the group of phosphorus-containing organic acids.

14. The method as claimed in claim 10, wherein the weight ratio of the bioactivator to the biocidally active, agriculturally acceptable active compound is from about 0.001 to about 200.

15. The method according to claim 14, wherein the ratio is from 0.03 to 50.

16. An aqueous storage-stable biocide composition having improved biocidal activity, which comprises from about 0.05 to about 50% by weight of a biocide selected from the group of the HB, FU, IN or PG and from about 0.5 to about 50% by weight of a bioactivator of the formula
R—C(O)NH—(CH₂)ₐ—N⁺(R¹,R²)—(CH₂)_{b}—COO⁻ (I)
in which
R is a hydrocarbon radical which is optionally branched and/or contains multiple bonds and/or functional groups,
R¹, R² independently of one another are alkyl radicals,
a is 1 to 5,
b is 1 or 2.

17. The aqueous storage-stable biocide composition according to claim 16, wherein the biological activator is a compound of the formula
R—C(O)NH—(CH₂)ₐ—N⁺(R¹,R²)—(CH₂)_{b}—COO⁻ (I)
in which
R is a hydrocarbon radical having 6 to 22 carbon atoms, which is optionally branched and/or contains multiple bonds and/or functional groups, R
1, R² independently of one another are C₁₋₄-alkyl radicals,
a is 1 to 5,
b is 1 or 2.

18. The aqueous biocide composition as claimed in claim 16, which further comprises as customary auxiliaries and additives, biocide-compatible salts, thickeners, antifoams, chelating agents, sulfactant and pH regulators.

19. A method for treating plants, which comprises applying the biologically active combination as claimed in claim 1 to the plants.

20. A method for regulating the growth of a plant, which comprises bringing the plant into contact with the biologically active combination as claimed in claim 1.

21. The method as claimed in claim 19, wherein the amount of biocidal active component and bioactivator in the biologically active combination is from about 0.01 to about 10 kg/ha.

22. The method as claimed in claim 20, wherein the amount of biocidal active component and bioactivator in the biologically active combination is from about 0.01 to about 10 kg/ha.

23. The method according to claim 21, wherein the amount is from about 0.5 to about 5 kg/ha.

24. The method according to claim 22, wherein the amount is from about 0.5 to about 5 kg/ha.

25. The biologically active combination according to claim 1 wherein the solvent is water.
